(19) United States
(12) Patent Application Publication
(10) Pub. No.: US 2026/0249468 A1
(43) Pub. Date: Aug. 27, 2026

(54) METHOD FOR GENERATING A SAFE ZONE OF A ROBOT, ELECTRONIC DEVICE AND COMPUTER READABLE MEDIUM

(71) Applicant: ABB SCHWEIZ AG, Baden (CH)

(72) Inventors: Yi Tong, Shanghai (CN); Shijing Lu, Guangzhou (CN); Shuang Gao, Shanghai (CN); Xiuxiu Yin, Shanghai (CN)

(21) Appl. No.: 19/650,096

(22) Filed: Apr. 16, 2026

Related U.S. Application Data
(63) Continuation of application No. PCT/CN2023/125047, filed on Oct. 17, 2023.

(51) Int. Cl. B25J 9/16; B25J 19/02; G06T 7/73; G06V 10/75

(52) U.S. Cl. CPC B25J 9/1676; B25J 19/023; G06T 7/73; G06V 10/751; G06T 2207/10028

(57) ABSTRACT

Embodiments of present disclosure relate to a method for generating a safe zone of a robot, electronic device and a computer readable medium. The method includes obtaining images or a video of a robot working scene from different angles of view; identifying objects in the images or the video, wherein the objects comprise the robot and at least one other object; obtaining size information and position information of the identified objects; and generating the safe zone of the robot based on the size information and the position information. In this way, the efficiency and accuracy of generating a safe zone are improved.

### FIELD

Embodiments of the present disclosure generally relate to the field of robot, and more particularly, to a method for generating a safe zone of a robot, electronic device and a computer readable medium.

### BACKGROUND

Robots are widely utilized in various fields. For example, robots are widely utilized in various industry applications to increase productivity. Safety is essential for both robot producers and users.

As is known, robot producers released a number of products to decrease the possibility of accidents. With the products, users need to predefine a safe zone with dimension information to limit the movement of the robot. In known solutions, the safe zone is generated by manual measurement or offline programming. Manual measurement is inefficient and imprecise, and offline programming has high requirements for engineers and requires the establishment of complex three-dimension models, which is costly and generally low in accuracy.

### SUMMARY

In view of the foregoing problems, various example embodiments of the present disclosure provide a method for generating a safe zone of the robot, and an electronic device and a computer readable medium to overcome at least one of the above mentioned defects or potential other defects.

In a first aspect of the present disclosure, example embodiments of the present disclosure provide a method for generating a safe zone of a robot. The method comprises: obtaining images or a video of a robot working scene from different angles of view; identifying objects in the images or the video, wherein the objects comprise the robot and at least one other object; obtaining size information and position information of the identified objects; and generating the safe zone of the robot based on the size information and the position information.

With such an arrangement, the images or the video of a robot working scene can be obtained conveniently, and the size information and position information of the objects can be determined accurately, and thus the efficiency and accuracy of generating a safe zone are improved.

In some embodiments, obtaining the images or the video of the robot working scene from different angles of view comprises: obtaining the images of the robot working scene from different angles of view captured by a mobile device with a camera; or obtaining the video of the robot working scene from different angles of view captured by a mobile device with a camera, and extracting the images from the video at a predefined frame rate.

With such an arrangement, the images or the video can be obtained easily and flexibly.

In some embodiments, the robot working scene is captured from different angles of view centered on the robot.

With such an arrangement, the objects in the images or the video can be identified efficiently, thereby reducing the computational intensity in a subsequent procedure.

In some embodiments, identifying objects in the images or the video comprises: identifying the robot and the at least one other object in the images or the video using an object identification algorithm; and labelling the identified objects in each of the images or the video.

With such an arrangement, the objects in the images or the video can be identified efficiently and accurately.

In some embodiments, obtaining size information and position information of the identified objects comprises: converting the images into binary pixel maps using a color space conversion function; and determining size and coordinates of the labelled at least one other object from the binary pixel maps.

With such an arrangement, the color images can be converted into binary pixel maps, thereby greatly reducing the computational intensity of determining the size and coordinates of the at least one other object.

In some embodiments, obtaining the size of the labelled at least one other object from the binary pixel maps comprises: determining a first number of binary pixels of a base along a line in a first direction; determining a ratio between a size of each binary pixel and a size of the base based on the first number and a known size of the base in the first direction; determining a second number of binary pixels of the labelled at least one other object; determining the size of the labelled at least one other object based on the second number and the ratio.

With such an arrangement, as the size of the robot is known, and thus the size of the at least one other object can be accurately determined based on the size of robot and the pixels of other object in the images.

In some embodiments, determining the coordinates of the labelled at least one other object from the binary pixel maps comprises: determining a first number of binary pixels of a base along a line in a first direction; determining a ratio between a size of each binary pixel and a size of the base based on the first number and a known size of the base in the first direction; determining a third number of binary pixels along a shortest line connecting the binary pixels of the labelled at least one other object and the binary pixels of the base; and determining the coordinates of the at least one other object based on the third number and the ratio.

With such an arrangement, the coordinates of the at least one other object can be accurately determined.

In some embodiments, generating the safe zone of the robot based on the size information and the position information comprises: fitting the size and coordinates of the at least one other object determined from each of the binary pixel maps to obtain an average size and average coordinates; and generating the safe zone of the robot based on the average size, the average coordinates and a known size and known coordinates of the robot.

With such an arrangement, by fitting the sizes and positions of the other objects from the images, an average size can be determined, and thus the safe zone for the robot can be accurately generated.

In some embodiments, generating the safe zone of the robot based on the average size, the average coordinates and a known size and known coordinates of the robot comprises: obtaining three dimensional point data of the objects based on the average size and the average coordinates; and determining a space represented by the three dimensional point data as the safe zone.

With such an arrangement, the safe zone can be efficiently and accurately generated.

In some embodiments, the method further comprises: obtaining a point cloud of the robot working scene, wherein the point cloud comprises distance information indicating distances between points in the point cloud; calibrating the size information and position information using the point cloud; and generating the safe zone based on the calibrated size information and position information.

With such an arrangement, by obtaining point cloud of the robot working scene, the size information and position information can be calibrated, thereby improving the accuracy of the generated safe zone for a robot.

In some embodiments, the method further comprises: control movement of the robot to a physical space corresponding to the safe zone using the data representing the safe zone of the robot.

With such an arrangement, by importing the data of the generated safe zone into a software of the robot, the software can limit the movement of the robot to a physical space corresponding to the safe zone, thereby ensuring the safety of the robot producers and users.

In a second aspect of the present disclosure, example embodiments of the present disclosure provide an electronic device for a robot, comprising: at least one processor; and at least one memory, coupled to the at least one processor and has instructions stored thereon, and the instructions cause the at least one processor to perform the method mentioned above when executed by the at least one processor. With such an arrangement, the efficiency and accuracy of generating a safe zone are improved.

In a third aspect of the present disclosure, example embodiments of the present disclosure provide a computer readable medium comprising program instructions for causing an apparatus to perform at least one of the method mentioned above. With such an arrangement, the efficiency and accuracy of generating a safe zone are improved.

It is to be understood that the summary section is not intended to identify key or essential features of embodiments of the present disclosure, nor is it intended to be used to limit the scope of the present disclosure. Other features of the present disclosure will become easily comprehensible through the following description.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a flow chart of a method for generating a safe zone of a robot in accordance with an embodiment of the present disclosure;

FIG. 2 is a perspective view of a robot working scene in accordance with an embodiment of the present disclosure;

FIG. 3 is a perspective view of a robot working scene in accordance with an embodiment of the present disclosure, wherein the objects are identified;

FIG. 4 is a binary pixel map of the robot working scene as shown in FIG. 3;

FIG. 5 is a schematic view of a robot working scene, wherein a safe zone of the robot is illustrated; and

FIG. 6 is a schematic flow chart of a method for generating a safe zone in accordance with another embodiment of the present disclosure.

Throughout the drawings, the same or similar reference symbols are used to indicate the same or similar elements.

### DETAILED DESCRIPTION OF EMBODIEMTNS

Principles of the present disclosure will now be described with reference to several example embodiments shown in the drawings. Though example embodiments of the present disclosure are illustrated in the drawings, it is to be understood that the embodiments are described only to facilitate those skilled in the art to better understand and thereby implement the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Safe zone of a robot is an important part of robot production and processing. Safety is essential for both robot producers and users because of plenty of accidents occurred in production line, which leads to huge loss to enterprise or users.

As mentioned in the background, robot producers released a number of products to decrease the possibility of accidents. With the products, users need to predefine a safe zone with dimension information to limit the movement of the robot. For example, emergency stop shall be triggered once the robot reaches out the redefined safe zone.

A relevant method for generating a safe zone is implemented mainly through manual measurement. That is, dimension information is obtained through manual measurement. As is known, the working environment of a robot is variable compared to robot's service time. Thus manual measurement is inefficient and imprecise. In particular, the manual measurement has the defects of low degree of intelligence, long time-consuming, high labor cost and other problems. Another method for generating a safety space is based on offline programming. In particular, the dimension information is obtained through offline programming. Offline programming has high requirements for engineers and requires the establishment of complex three-dimension models, which is costly and generally low in accuracy.

As can be seen from the above, the relevant methods for generating the safe zone have defects such as low efficiency, high cost, and low accuracy.

In view of the forgoing, according to embodiments of the present disclosure, a new method for generating a safe zone of a robot is provided in the present disclosure. The method comprises: obtaining images or a video of a robot working scene from different angles of view; identifying objects in the images or a video, wherein the objects comprise the robot and at least one other object; obtaining size information and position information of the identified objects; and generating the safe zone of the robot based on the size information and the position information. In this way, efficiency and accuracy of generating a safe zone are improved. The above idea may be implemented in various manners, as will be described in detail in the following paragraphs.

In some embodiments of the present disclosure, it proposes to use mobile devices to capture images or a video of the robot working scene, then use image processing algorithm to identify objects in the images or video, and calculate the three-dimensional geometric parameters of each object, whereby estimating the safe zone of the robot.

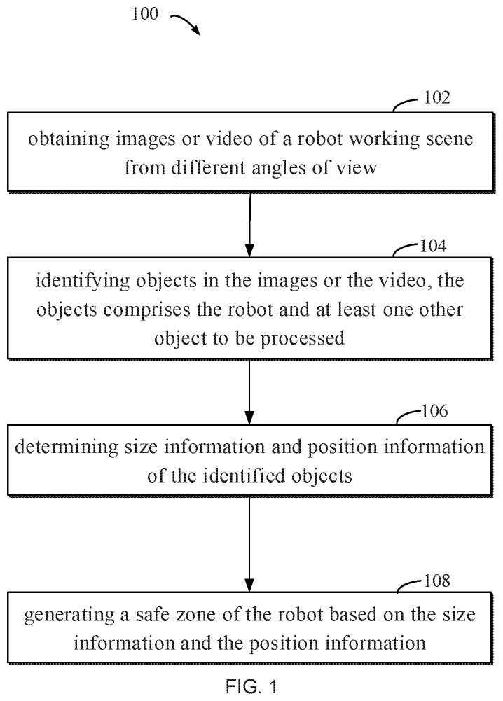

Hereinafter, the principles of the present disclosure will be described in detail with reference to FIGS. 1-6.

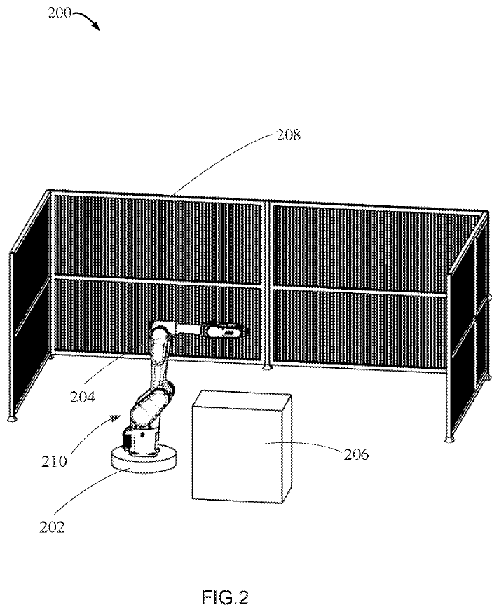

Referring to FIG. 1 first, FIG. 1 is a flow chart of a method 100 for generating a safe zone of a robot in accordance with an embodiment of the present disclosure. FIG. 1 will be described in conjunction with FIGS. 2-5.

As shown in FIG. 1, at block 102, images or the video of a robot working scene 200 are obtained from different angles of view. This process will be described in conjunction with FIG. 2.

FIG. 2 is a perspective view of a robot working scene 200 in accordance with an embodiment of the present disclosure. Referring to FIG. 2, some objects including a robot 210 and an object to be processed 206 (also referred to as other object for simplicity) are located in the robot working scene 200. The robot 210 includes a base 202 and an arm 204 coupled with the base 202. Processing cage 208 (only a part of which is illustrated in FIG. 2) is arranged around the robot 210 and the other object 206. The processing cage 208 defines a robot working space. Only one other object 206 is shown in FIG. 2, the present disclosure does not limit on this respect, more than two other objects 106 may be arranged in the robot working scene 200.

In some embodiments, the robot working scene 200 may be captured from different angles of view by a device to obtain the images. For example, a mobile phone with a camera may be used to capture the robot working scene 200. Due to the widespread use of mobile phones, it is very convenient to obtain images of the robot wording scene 200.

In some embodiments, the robot working scene 200 may be captured from different angles of view using a mobile device with a camera to obtain a video. The video is composed of images frame by frame. Images may be extracted from the video at a predefined frame rate. For example, the camera may take 60 frames in one second. In this way, the images can be extracted from the video as needed, thereby reducing the time spent capturing images. In some cases, calculating the 60 frames may be too computationally intensive. For the sake of reducing computational intensity, for example, 10 frames may be evenly extracted from the video, and thus the content of 60 frames is compressed into 10 frames. That is, frame rate can be set as needed to compress the video, thereby accelerating computational speed.

In some embodiments, the robot working scene 200 is captured from different angles of view centered on the robot 210. That is, the robot working scene 200 can be shot by a mobile device around the robot working scene 200. In this process, the robot is always in the center of the field of view, such that in each captured image, the robot is substantially located in the center of the image. In this way, the objects in the images can be identified efficiently, which is helpful to reduce the computational intensity in a subsequent procedure. This will be further described below.

At block 104, the objects in the images or the video are identified, wherein the objects comprise the robot 210 and at least one other object 206 to be processed.

In some embodiments, the robot 210 and the at least one other object 206 in the images are identified using an object identification algorithm. After the objects in the images have been identified, the identified objects in each of the images will be labelled with for example a block.

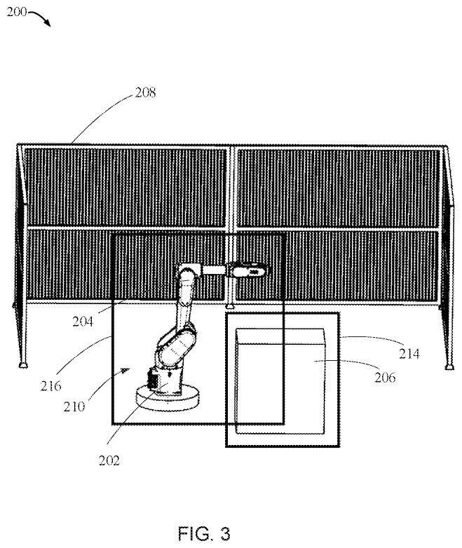

With reference to FIG. 3, FIG. 3 is a perspective view of a robot working scene 200 in accordance with an embodiment of the present disclosure, wherein the objects may be identified for example by a segmentation network. As shown in FIG. 3, the identified robot 210 is labelled with a first box 216, and the identified other object 206 is labelled with a second box 214.

In some embodiments, after obtaining the images, a graphics processing method may be used to segment the images and identify the objects in the images. In this way, it can be determined which one is the robot and which ones are the other objects.

Specifically, in some embodiments, the objects in the images can be identified through instance segmentation and semantic segmentation.

### (1) Semantic Segmentation

Semantic segmentation is a pixel-level segmentation. Each pixel in the image is divided into corresponding categories. That is, pixel-level classification is achieved. Specifically, semantic segmentation divides the image into categories based on features such as grayscale, color, spatial texture, and geometric shapes. Several disjoint regions make these features show consistency or similarity within the same region, but show obvious differences between different regions. Simply put, it is to separate the target from the background in an image. For grayscale images, pixels within a region generally have grayscale similarity, while pixels within a region generally have grayscale discontinuity at the boundaries of the region. Through semantic segmentation, the robot 210 and the other object 206 can be distinguished from the background.

### (2) Instance Segmentation

In instance segmentation, the specific object of a categories is an instance, so instance segmentation not only requires pixel-level classification, but also needs to distinguish different instances on the basis of specific categories. For example, if there are multiple people A, B, and C in the image, their semantic segmentation results are all people, but the instance segmentation results are different objects. As can be seen, instance segmentation is a further task than semantic segmentation and is more difficult.

In some embodiments, using Mask RCNN (Regions with CNN features) architecture to identify instances of objects in images.

As mentioned above, the robot 210 is always in the center of the field of view, such that in each captured image or video, the robot 210 is substantially located in the center of the image. The purpose of this is to minimize recognition intensity when performing Mask RCNN segmentation. Mask RCNN will recognize many objects. In order to know which of these objects is the robot 210 as soon as possible, the best way is to tell it in advance. If the robot 210 is in the center of the field of view, then the object in the center of the image will be identified quickly as the robot 210. In an image frame, since the video was shot centered on the robot 210, the content in the center of the image will be the robot 210, and everything else is the other object. Thus the speed of identification is improved.

After the objects in the images are identified, they will be labelled. Specifically, a mark will be labelled on each image, as shown in FIG. 3.

Return to FIG. 1, at block 106, the size information and position information of the identified objects is obtained.

As mentioned above, the objects in the images are identified. After the objects is identified, a further processing is performed. In some embodiments, in order to determine the size of the objects, the images are converted into binary pixel maps. In other words, the images are converted into black and white pictures. Specifically, the images may be converted into binary pixel maps using a color space conversion function. That is, the size information may be estimated using black and white pixels. The purpose is to conveniently extract pixels from the pixel map.

Since the size and coordinates of the robot 210 is known in advance, the distance between the other object 206 and the robot 210 and the positions of the other objects 106 can be determined from the pixel map based on the size and coordinates of the robot 210. A two dimensional information of an object may be determined from an image. Since at least two images from different angles of view have been acquired, three dimensional information may be determined from these images. This will be described in detail below.

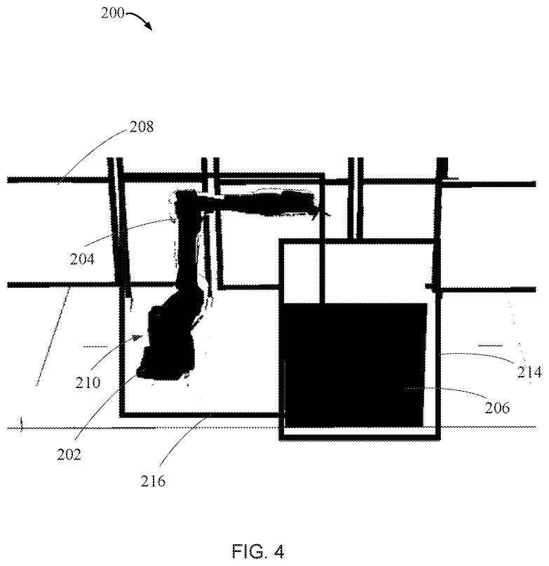

Referring to FIG. 4, FIG. 4 is a pixel map of the robot working scene 200 as shown in FIG. 3. As shown in FIG. 4, the pixel map is a picture of objects with the background removed, in which black represents the objects and white represents the background, so the black pixels contain the valid information of the objects. The converted pixels just change from a colored RGB image to binary value pixels. The related computation is transformed from a three-dimensional matrix into a two-dimensional matrix. Thus computational intensity will be greatly reduced, and the size information and position information of the objects may be determined efficiently.

After the images are converted into binary pixel maps, a feature matching method may be used to find the base 202 or the arm 204 of the robotic from the binary pixel maps. The base 202 or the arm 204 may be used as a reference to estimate the size and coordinates of the other objects 206. Then the size and coordinates of the labelled other object 206 may be obtained from the binary pixel maps. In particular, the size of the object can be determined by the number of pixels.

In general, the geometric dimensions of the robot 210 are known in advance. For example, the size of the robot 210, in particular, the size of the base of the robot 210 and the size of the robotic arm can be considered as known content. Thus the geometric dimensions of the robot 210 may be used to determine the size of other objects 106. That is, the geometric parameters of other objects 106 can be estimated based on the size of the robot 210. For example, if the diameter of the robot base is 50 cm, and the picture contains 50 pixels along the diameter direction, then it can be derived that the size of one pixel is 1 cm. By using this proportional relationship, the size and coordinates of the other objects 106 in the image can be obtained.

All objects in each picture has such a proportional relationship. For example, the number of pixels in the base of different pictures taken at different distances will change, while the number of pixels in other objects 106 will also change proportionally.

Therefore, the proportional relationship mentioned above may serve as a reference to determine the size and coordinates of the other objects 106 in the pictures.

In some embodiments, the size of the labelled at least one other object 206 may be determined from the binary pixel maps through the following manner. First, a first number of binary pixels of the base 202 along a line in a first direction may be determined. For example, the line may be a diameter of the base. Then, a ratio between the size of each binary pixel and the size of the base 202 may be determined based on the first number and the known size of the base 202 in the first direction. After that, a second number of binary pixels of the labelled at least one other object 206 may be determined. Finally, the size of the labelled at least one other object 206 may be determined based on the second number and the ratio. For the same binary pixel map, all objects have the same ratio.

Similarly, in some embodiments, the coordinates of each of the objects may be determined from the binary pixel maps in the following manner. First, a first number of binary pixels of the base 202 may be determined. Then, a ratio between a size of each binary pixel and a size of the base 202 may be determined based on the first number and the known size of the base 202. After that, a third number of binary pixels along a shortest line between the binary pixels of the labelled at least one other object 206 and the binary pixels of the base 202 may be determined. Finally, the coordinates of the at least one other object 206 may be determined based on the third number and the ratio.

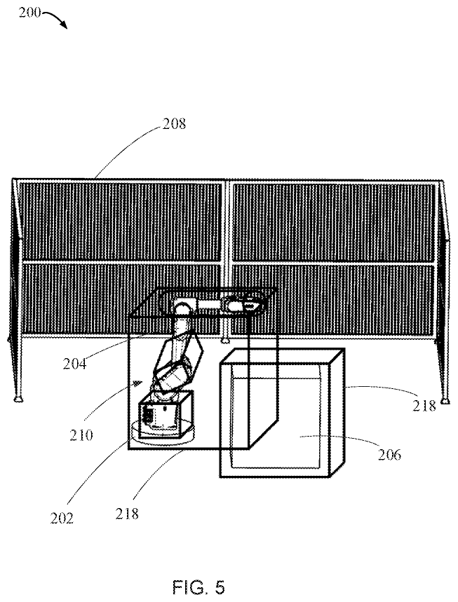

Return to FIG. 1, at block 108, a safe zone of the robot 210 is generated based on the size information and the position information. This process will be described in conjunction with FIG. 5.

Referring to FIG. 5, FIG. 5 is a schematic view illustrating a safe zone of the robot 210. As shown in FIG. 5, safe zone 218 are generated. The safe zone 218 enclose the robot 210 and the other object 206.

In some embodiments, generating a safe zone of the robot 210 based on the size information and the position information comprises: fitting the sizes and positions of the at least one other object 206 determined from each of the binary pixel maps to obtain average size and the average coordinates; and generating the safe zone 218 of the robot 210 based on the average size and average coordinates and a known size and coordinates of the robot 210.

The purpose of fitting lies in that: due to the capture of multiple images and the different distances between the camera and the objects, the size of the resulting image varies, and the estimated object size also varies. Because it is necessary to obtain the data of objects in these images, the most reliable value needs to be obtained. This requirement may be met by the process of fitting. The method of fitting used here is not described in detail, it can be either the known average value method or the known least squares method, etc.

In some embodiments, generating the safe zone 218 of the robot 210 based on the average size and average coordinates and a known size and positon of the robot 210 comprises: obtaining three dimensional point data of the objects based on the average size and average coordinates; and determining a space represented by the three dimensional point data as the safe zone 218. The three dimensional point data of the objects can represent the dimension of the safe zone 218 of the robot.

In some embodiments, a mobile device may include a radar sensor, such as a lidar, which can scan the robot working scene 200 to generate 3D point cloud data. The 3D point cloud data can be used to calibrate the calculated size and coordinates. In this way, the accuracy of the calculated size and coordinates will be improved.

The mobile device can be equipped with a radar sensor or an ordinary camera or both. The radar sensor can additionally output point cloud, which contain information about the scanned points. In particular, the point cloud may include distance information indicating distances between various points. A mobile phone with ordinary camera outputs pictures, while a mobile device with a radar sensor can output both the pictures and the point cloud.

As indicated above, a device with a lidar can directly obtain the information of the scanned point, and the information of the scanned point and the data generated from the previous video can be used to generate a safe zone. Specifically, the point cloud of lidar is compared with the calculated data. If there is an error, compensation may be made.

In some embodiments, the point cloud of the robot working scene 200 may be obtained. The size information and position information obtained may be calibrated using the point cloud. The safe zone 218 may be generated based on the calibrated size information and position information.

In some embodiments, the data representing the safe zone of the robot 210 may be imported into a control software of the robot 210 to limit the movement of the robot 210 to a physical space corresponding to the safe zone 218. In this way, the robot 210 can be limited within a predefined zone, ensuring the safety of the robot producers and users.

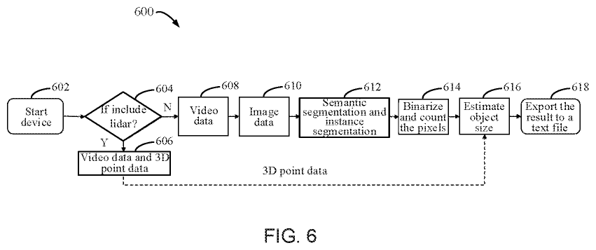

The disclosure of the invention will be further described below with reference FIG. 6. FIG. 6 is a schematic flow chart of a method 600 for generating a safe zone 218 in accordance with another embodiment of the present disclosure.

At block 602, a device such as a mobile phone is started.

At block 604, it is determined if the device includes a lidar. If it is determined that the device includes a lidar, then the procedure proceeds to block 606. If it is determined that the device does not include a lidar, the procedure proceeds to block 608.

At block 606, the device captures video data and 3D point data (point cloud).

At block 608, the device captures video data.

At block 610, image data are extracted from the video data.

At block 612, semantic segmentation and instance segmentation are implemented to identify the objects in the images.

At block 614, the images are binarized into binary pixels, and the binary pixels are counted.

At block 616, the size of the objects is estimated based on the numbers of the binary pixels.

At block 618, the result may be exported to, for example a text file. The text file may be used by a control software to control the movement of the robot 210.

A method for generating a safe zone 218 is described with reference to FIGS. 1 to 6. It is to be understood that the method for generating a safe zone 218 is only illustrative. The scope of the present disclosure is not intended to be limited in this respect. The method may be implemented in various manner in accordance with embodiments of the present disclosure.

In some embodiments, an electronic device for a robot 210 is provided. The electronic device comprises: at least one processor; and at least one memory, coupled to the at least one processor and has instructions stored thereon, and the instructions cause the at least one processor to perform the method mentioned above when executed by the at least one processor.

In some embodiments, a computer readable medium is provided. The computer readable medium comprises program instructions for causing an apparatus to perform at least one of the method mentioned above.

The solutions provided by the embodiment of the present disclosure solve the problems of high cost, low efficiency mentioned above.

In this disclosure, the safe zone 218 is obtained through calculation, which is a three-dimensional space described by data points. The obtained safe zone 218 (data points) may then be used to control the movement of the robot 210. For example, the data points representing the safe zone 218 may be imported into a software to control the robot's actions and limit its movement range to a physical space corresponding to the safe zone 218 represented by the data points.

In some embodiments, it proposes to use a scene video recorded by mobile device to generate the safe zone 218 of the robot 210, which saves the cost of measuring the safe zone 218, quickly generates the safe zone 218 of the robot in the robot working environment, improves the processing efficiency, and enhances the functionality of a control software. This method fills the gap of the safe zone generation of the current robot processing software. The result can also be used as an input for the robot 210 to do motion planning.

The solution of the present disclosure has significantly improved the efficiency and accuracy of generating a safe zone, and reduced the cost.

The embodiments of the present disclosure may be implemented by means of a program so that a device may perform any process of the disclosure as discussed with reference to the Figures. The embodiments of the present disclosure may also be implemented by hardware or by a combination of software and hardware.

In some embodiments, the program may be tangibly contained in a computer readable medium which may be included in the device (such as in a memory) or other storage devices that are accessible by the device. The device may load the program from the computer readable medium to a RAM for execution. The computer readable medium may include any types of tangible non-volatile storage, such as ROM, EPROM, a flash memory, a hard disk, CD, DVD, and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods as described above with reference to the Figures. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method for generating a safe zone of a robot, comprising:
obtaining images or a video of a robot working scene from different angles of view;
identifying objects in the images or the video, wherein the objects comprise the robot and at least one other object;
obtaining size information and position information of the identified objects; and
generating the safe zone of the robot based on the size information and the position information.

2. The method according to claim 1, wherein obtaining the images or the video of the robot working scene from different angles of view comprises:
obtaining the images of the robot working scene from different angles of view captured by a mobile device with a camera; or
obtaining the video of the robot working scene from different angles of view captured by a mobile device with a camera, and extracting the images from the video at a predefined frame rate.

3. The method according to claim 2, wherein the robot working scene is captured from different angles of view centered on the robot.

4. The method according to claim 1, wherein identifying objects in the images or the video comprises:
identifying the robot and the at least one other object in the images or the video using an object identification algorithm; and
labelling the identified objects in each of the images or the video.

5. The method according to claim 4, wherein obtaining size information and position information of the identified objects comprises:
converting the images into binary pixel maps using a color space conversion function; and
determining size and coordinates of the labelled at least one other object from the binary pixel maps.

6. The method according to claim 5, wherein obtaining the size of the labelled at least one other object from the binary pixel maps comprises:
determining a first number of binary pixels of a base along a line in a first direction;
determining a ratio between a size of each binary pixel and a size of the base based on the first number and a known size of the base in the first direction;
determining a second number of binary pixels of the labelled at least one other object;
determining the size of the labelled at least one other object based on the second number and the ratio.

7. The method according to claim 5, wherein determining the coordinates of the labelled at least one other object from the binary pixel maps comprises:
determining a first number of binary pixels of a base along a line in a first direction;
determining a ratio between a size of each binary pixel and a size of the base based on the first number and a known size of the base in the first direction;
determining a third number of binary pixels along a shortest line connecting the binary pixels of the labelled at least one other object and the binary pixels of the base; and
determining the coordinates of the at least one other object based on the third number and the ratio.

8. The method according to claim 5, wherein generating the safe zone of the robot based on the size information and the position information comprises:
fitting the size and coordinates of the at least one other object determined from each of the binary pixel maps to obtain an average size and average coordinates; and
generating the safe zone of the robot based on the average size, the average coordinates and a known size and known coordinates of the robot.

9. The method according to claim 8, wherein generating the safe zone of the robot based on the average size, the average coordinates and a known size and known coordinates of the robot comprises:
obtaining three dimensional point data of the objects based on the average size and the average coordinates; and
determining a space represented by the three dimensional point data as the safe zone.

10. The method according to claim 1, further comprising:
obtaining a point cloud of the robot working scene, wherein the point cloud comprises distance information indicating distances between points in the point cloud;
calibrating the size information and position information using the point cloud; and
generating the safe zone based on the calibrated size information and position information.

11. The method according to claim 1, further comprising:
controlling movement of the robot to a physical space corresponding to the safe zone using the data representing the safe zone of the robot.

12. An electronic device for a robot, comprising:
at least one processor; and
at least one memory, coupled to the at least one processor and has instructions stored thereon, and the instructions cause the at least one processor to perform the method of claim 1 when executed by the at least one processor.

13. A non-transitory computer readable medium comprising program instructions for causing an apparatus to perform at least one of the method of claim 1.
